(19) United States
(12) Patent Application Publication
(10) Pub. No.: US 2008/0148293 A1
(43) Pub. Date: Jun. 19, 2008

(54) Configurable event broker

(76) Inventors: Adrian Cowham, Roseville, CA (US); Devon L. Dawson, Roseville, CA (US); Daniel E. Ford, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/581,837

(22) Filed: Oct. 17, 2006

(51) Int. Cl. G06F 9/46

(52) U.S. Cl. 719/321

(57) ABSTRACT

An event broker that receives various types of events in a particular device, and decodes the events to a common meaning form as a generic event that is accessible by various software applications in the device. The event broker includes a plurality of event receivers that receive the events on various ports of the device. The events are then transferred to an event driver loader that accesses a particular event driver depending on how the particular event is formatted. The event driver decodes the event and stores the generic event in an event storage system and/or passes it on to a particular software module that may need to use the event at that particular time.

### BACKGROUND

Various computer hardware devices, such as PCs, printers, telephones, etc., receive various types of events, such as SNMP traps, Syslog messages, application events, etc., and act on the events in some manner. Generally, the events are received by the device on different ports, which requires a separate event receiver at each port. The events may include critical information needed by software applications running in the particular device. Particularly, various software applications within the device, such as network browsers, Microsoft Outlook™, etc., may perform some function in response to the event received by the device.

The various events received by the device are typically coded or formatted in some manner, where different types of events are typically formatted in a different manner and the same type of events may also be formatted in a different manner. Therefore, the software applications must decode or parse the events to extract the information therefrom. Thus, it is necessary to provide software that is able to decode multiple events from many sources, and is extensible to decode updated or new types of events.

One solution to this problem is to only allow the particular application or device to receive events that are formatted or coded in a particular manner. However, this solution provides limitations as to the ability of the particular device to receive information from multiple sources.

Another solution to the problem is to have a plurality of event receivers in the device, where each event receiver decodes events formatted in a particular manner. For example, a particular event receiver may be responsible for only receiving and decoding SNMP traps, and then passing the decoded event to a particular software application. Therefore, each receiver is required to have its own separate decoder processor. However, providing a decoder processor in each receiver adds cost to the system. Further, there is an efficiency issue because as a particular event receiver receives a string of events, the decoding process may prevent events from being immediately passed on to the software application as a result of the time it takes to decode the events.

In another known technique, the event is immediately passed from the event receiver to the parent software application, which may store the event in a memory device. When a particular child software application of the parent software application needs the information in the event, it will access the memory, and then decode the event for its use. However, this requires that each of the various child software applications in the parent software application needs to be able to decode many different types of event formats where the decoding ability would be provided in many different child software applications. This requirement has significant implications for the maintainability and extensibility for adding future event formats to the software applications. Therefore, it would be desirable to provide a better software application for decoding events as they are received in a particular device.

### BRIEF DESCRIPTION OF THE DRAWINGS

FIG. 1 is a block diagram of a system that includes an event broker for decoding events; and

FIG. 2 is a flow chart diagram showing the operation of the event broker in FIG. 1.

### DETAILED DESCRIPTION OF THE EMBODIMENTS

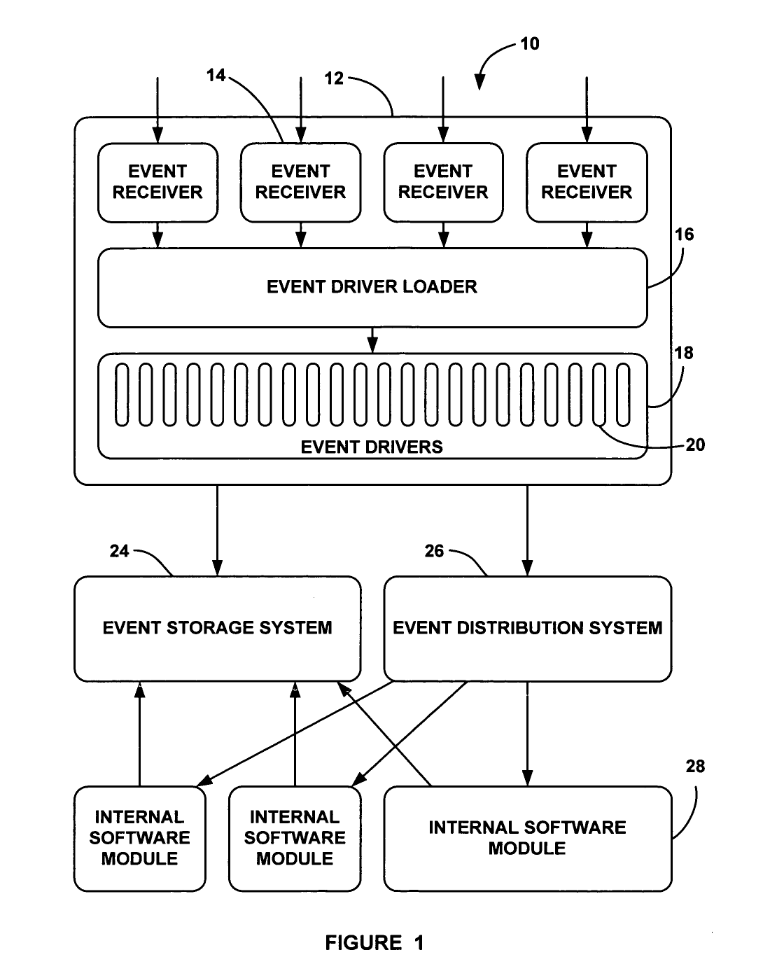

FIG. 1 is a block diagram of a computer system 10 that includes an event broker 12 that decodes or parses various types of events, such as SNMP traps, Syslog messages, internal application events, etc. The event broker 12 includes a plurality of event receivers 14 that receive the events at different ports in the system 10, as is well understood to those skilled in the art. The event receivers 14 are receiver software applications running in the event broker software application. Alternately, the event receivers 14 do not need to be tied to a particular port, but can be connected to a single port depending on the specific device that the event broker 12 is being used in. Further, the event receivers 14 can represent any type of connection between software applications, such as inter-process communications, TCP/UDP ports, shared memory, etc. Additionally, the event receivers 14 could be internal to a particular application.

Each event receiver 14 passes the event to an event driver loader 16 that is also a piece of software running in the event broker software application. Based on an unique identification (ID) number in the event that identifies its particular coding format, the event driver loader 16 will load the applicable event driver 20 from a plurality of event drivers 20 stored in a memory 18. When the system 10 is started, the event driver loader 16 generates a map of the location of each of the event drivers 20 based on the unique ID that identifies what type of event format the event drivers 20 will be able to decode. The event drivers 20 are separate pieces of software that decode a particular type of event into a common language format. Particularly, each event driver 20 formats the particular event into a particular output, generates a dictionary for the particular event using predetermined common words know to all of the software applications, and then returns a generic formatted event to the event driver loader 16. The event driver 20 knows how to extract and map the event values to the dictionary names. Therefore, the particular event will be in a format where all of the various software applications running in the system 10 will be able to use the event by extracting pertinent data from the events dictionary that was previously encoded. In this manner, the event broker 12 is extensible because it allows additional event drivers 20 to be stored in the memory 18. Also, if a particular event driver 20 needs to be upgraded, a suitable file can be downloaded to the system 10 to perform that function.

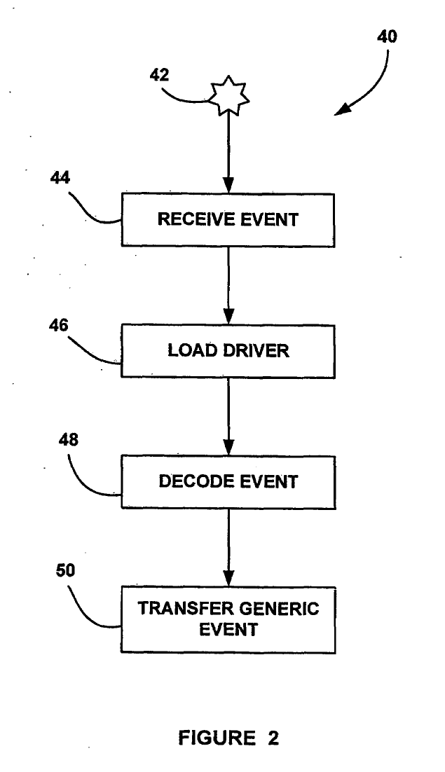

FIG. 2 is flow chart diagram 40 showing the process of using the event broker 12 as described above. A particular event 42 is received at box 44, and may arrive in different fashions, such as SNMP traps arrive on UDP port 162, Syslog messages arrive on UDP port 514, and internal application events arrive differently depending on a particular software system. When the event 42 is received, the event receiver 14 passes the unique ID of the event 42 and the event 42 to the event driver loader 16 at box 46. The event driver loader 16 then accesses the particular event driver 20 at box 48 to decode the event. Because the driver 20 is loaded using a unique event identifier, it knows the format and structure of the event 42 so that it can extract and apply important information encoded in the event. This information can be, but is not limited to, the event source, VLAN information, end-node information, such as an IP address, MAC address, etc., and port information, such as port name or port number.

When the event driver 20 decodes all of the relevant information, it builds a dictionary by mapping well-known names to the decoded information. The dictionary is necessary because the various child software applications running in a particular parent software system may need to know that an event has been received, and the information that it contains. For example, the software system may be a network management software system that includes various types of child software applications. The event broker software would be one of the child software applications running in the parent software system. When the event broker 12 generates the dictionary for the particular event, it passes that dictionary to the parent software system. The parent software system would then notify all of the child software applications that may need to know the information in the particular event.

By decoding the information in an event to common terms in a dictionary format, each particular child software application that needs to know that information can readily access it directly through the generic event. Particularly, when the event driver 20 decodes the original event it creates the generic event and the dictionary for that event. The dictionary is attached to the generic event so that access to an events dictionary is gained by first accessing the event. Thus, all of the various software applications will know the particular meaning of the well-known names established in the dictionary. Each software application is able to access a list of well-known names from particular information that are entries in the event dictionary. For example, when a port down event is received by a software application it may want to automatically turn that port back on. The child software application can then access the events dictionary, retrieve the port number, and turn it back on.

Once the event driver 20 decodes the event, the event broker 12 transfers the generic event to an event storage system 24 in the parent software system at box 50. Additionally, the generic event can be sent to an event distribution system 26 inside the parent software system to be distributed to the many internal software modules 28 that represent the child software applications. Alternately, the event broker 12 can do both things, particularly, send the generic event to the event storage system 24 and distribute the generic event using the event distribution system 26. Therefore, the internal software modules 28 may receive the generic events immediately as they are decoded by the event broker 12, or the internal software modules 28 may later access the generic event from the data base in the event storage system 24. The internal software modules 28 can generally be software applications that need to know about the events in real time, need to know about events later after they are received, or do not need to know about the events. Therefore, the generic events are stored in the storage system 24 or distributed to the applicable software modules 28 by the event distribution center 26.

The event broker 12 offers a number of advantages. Particularly, when the event broker 12 is configured to accept a new type of event, it builds the same dictionary as the other events that were previously known by the various software applications. The internal software modules 28 don't know and don't care about the source or type of event. Further, the event broker 12 facilitates development of a software system that involves event processing. Only the event broker 12 has to be told about a new event, thus making the amount of code changes minor. Thus, the event broker 12 also allows child software modules to uniformly get potentially crucial data that was previously encoded in a format unknown to the child software modules. This sets the stage for event driven actions, that is, having events trigger actions and allowing actions to have a way to uniformly extract any pertinent data.

The foregoing discussion discloses and describes merely exemplary embodiments. One skilled in the art will readily recognize from such discussion, and from the accompanying drawings and claims, that various changes, modifications or variations can be made therein without departing from the spirit and scope of the embodiments as defined in the following claims.

What is claimed is:

1. A method for decoding events in a software system, said method comprising:
receiving the events;
transferring the events to a driver loader;
selecting a particular event driver from a plurality of event drivers depending on how the particular event is formatted;
decoding the events using the selected event driver; and
creating generic events from the decoded events that include common terms usable by a plurality of software applications running in the software system.

2. The method according to claim 1 further comprising storing the generic events in a storage device.

3. The method according to claim 1 further comprising distributing the generic events to the plurality of software applications.

4. The method according to claim 1 wherein receiving the events includes receiving the events by a plurality of event receivers.

5. The method according to claim 4 wherein a separate event receiver is assigned to each port of a device running the software system.

6. The method according to claim 4 wherein the plurality of event receivers are coupled to a single port of a device running the software system.

7. The method according to claim 1 wherein creating the generic events includes building a dictionary by mapping well-known names to decoded information from the decoded events.

8. The method according to claim 1 wherein selecting a particular event driver includes identifying the event format by a unique identification number associated with the event.

9. The method according to claim 1 wherein the events are selected from the group consisting of SNMP traps, Syslog messages and internal application events.

10. A software system for decoding events received by a device, said software system comprising:
at least one event receiver for receiving the events;
a driver loader responsive to the events received by the at least one receiver; and
a plurality of event drivers, said driver loader selecting one of the event drivers depending on how the received event is formatted, said selected event driver decoding the event and creating generic events from the decoded events that include common terms usable by a plurality of software applications running in the software system.

11. The system according to claim 10 further comprising a storage device for storing the generic events.

12. The system according to claim 10 further comprising a distribution sub-system for distributing the generic events to the plurality of software applications.

13. The system according to claim 10 wherein the at least one event receiver is a plurality of event receivers.

14. The system according to claim 13 wherein a separate event receiver is assigned to each port of the device.

15. The system according to claim 13 wherein the plurality of event receivers are coupled to a single port of the device.

16. The system according to claim 10 wherein the selected event driver builds a dictionary by mapping well-known names to decoded information from the decoded events.

17. The system according to claim 10 wherein the driver loader selects a particular event driver by identifying a unique identification number associated with the event identifying its coding format.

18. The system according to claim 10 wherein the events are selected from the group consisting of SNMP traps, Syslog messages and internal application events.

19. A software system for decoding events received by a device, said software system comprising:
a plurality of event receivers for receiving the events;
a driver loader responsive to the events received by the receivers;
a plurality of event drivers, said driver loader selecting one of the event drivers depending on how the received event is formatted, said selected event driver decoding the event and creating generic events from the decoded events that include common terms usable by a plurality of software applications running in the software system, wherein the selected event driver builds a dictionary by mapping well-known names to decoded information from the decoded events, and wherein the driver loader selects a particular event driver by identifying a unique identification number associated with the event identifying its coding format;
a storage device for storing the generic events; and
a distribution sub-system for distributing the generic events to the plurality of software applications.

20. The system according to claim 19 wherein a separate event receiver is assigned to each port of the device.
